(19) United States
(12) Patent Application Publication
(10) Pub. No.: US 2011/0156960 A1
(43) Pub. Date: Jun. 30, 2011

(54) ANTENNA MODULE

(75) Inventors: YEN-JUNG TSENG, Tu-Cheng (TW); CHO-KANG HSU, Tu-Cheng (TW)

(73) Assignee: CHI MEI COMMUNICATION SYSTEMS, INC., Tu-Cheng City (TW)

(21) Appl. No.: 12/836,669

(22) Filed: Jul. 15, 2010

(30) Foreign Application Priority Data
Dec. 30, 2009 (TW) 98146047

(51) Int. Cl. H01Q 9/04

(52) U.S. Cl. 343/700 MS

(57) ABSTRACT

The disclosure provides an antenna module used for a portable device. The antenna module includes a first antenna part, a second antenna part, a third antenna part, a feed part, and a ground part. The first antenna part and the second antenna part are separated to encircle an adjustment space operable to adjust assembly of the antenna module. The third antenna part is disposed by the side of the first antenna part and the second antenna part. The feed part and the ground part are parallel to each other. The first antenna part and the second antenna part jointly connect with the feed part. The second antenna part and the third antenna part jointly connect with the ground part.

### BACKGROUND

1. Technical Field

The present disclosure relates to an antenna module used for a portable device.

2. Description of Related Art

Portable devices such as mobile phones, personal digital assistants (PDA) and laptop computers are widely used. Antennas are installed in such portable devices to receive/send wireless signals. Generally, the antennas may receive/send wireless signals of different frequencies (e.g., DCS1800, PCS1900, UMTS2100, etc.), requiring that the antennas be multiband antennas.

However, most conventional multiband antennas have complicated structures and are large, despite most current portable devices being small with insufficient space to install the multiband antennas. Even if some miniaturized multiband antennas can be installed in the portable devices, they are difficult to be installed precisely, and communication quality of the portable devices may be affected.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

FIG. 1 is a schematic view of an antenna module disposed on a housing from a first perspective.

FIG. 2 is a schematic view of the antenna module of FIG. 1 from a second perspective.

FIG. 3 is a schematic view of the antenna module of FIG. 1 from a third perspective.

FIG. 4 is a measurement diagram of return loss of the antenna module of FIG. 1.

### DETAILED DESCRIPTION

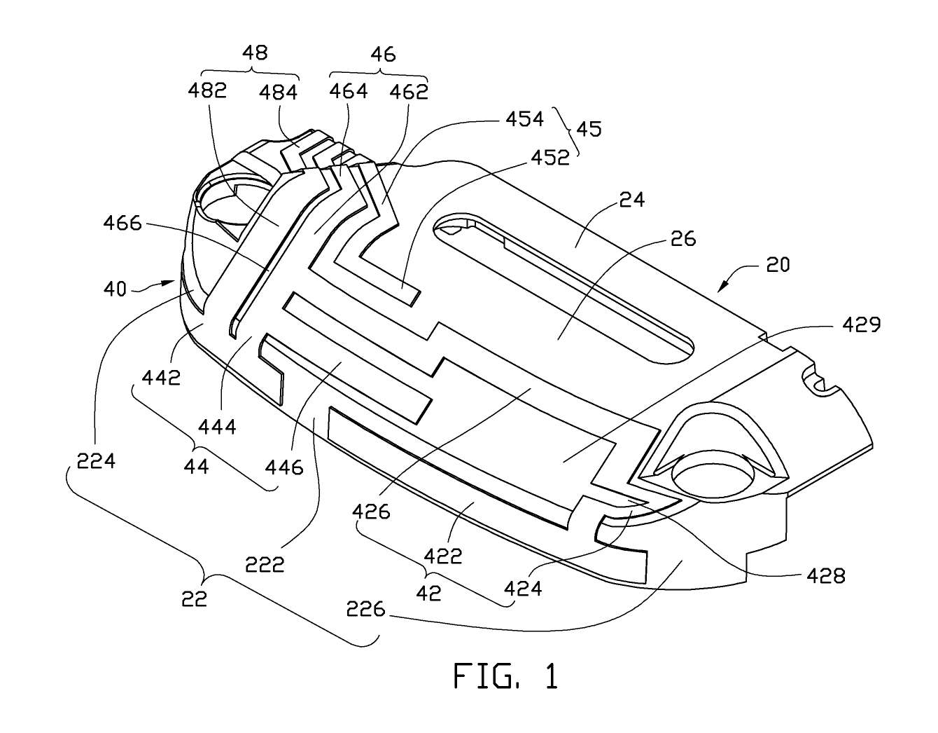

FIG. 1 is a schematic view of an antenna module 40 disposed on a housing 20 of a portable device (not shown) from a first perspective. The portable device may be a mobile phone, a personal digital assistant (PDA), or a laptop computer, for example. In the exemplary embodiment, the portable device is a mobile phone. The antenna module 40 is installed in the portable device to receive/send wireless signals. The antenna module 40 is made of metal material and includes a first antenna part 42, a second antenna part 44, a third antenna part 45, a feed part 46, and a ground part 48. The first antenna part 42 and the second antenna part 44 are separated to encircle an adjustment space 429. The adjustment space 429 is operable to adjust assembly of the antenna module 40. The third antenna part 45 is disposed by the side of the first antenna part 42 and the second antenna part 44. The feed part 46 and the ground part 48 are parallel to each other. The first antenna part 42, the second antenna part 44, and the third antenna part 45 are operable to generate signals of different resonant frequencies in response to radio frequency signals fed in the feed part 46.

The housing 20 includes a side surface 22, an upper surface 24, and a connecting surface 26. The side surface 22 includes a middle portion 222 and two cambered side portions 224, 226. The connecting surface 26 is cambered and connects the side surface 22 and the upper surface 24.

The first antenna part 42 is a resonant antenna and includes a main body 422, a first electric connecting part 424, and a second electric connecting part 426. The main body 422 is rectangular and disposed on the middle portion 222 and the cambered side portion 226. A portion of the main body 422 further reaches the connecting surface 26. The first electric connecting part 424 is disposed on the connecting surface 26 with the form of camber. The first electric connecting part 424 connects with the main body 422 and further forms a first groove 428 operable to adjust an electric length of the first antenna part 42. The second electric connecting part 426 connects with the first electric connecting part 424 and is parallel to the main body 422. The second electric connecting part 426 is in the form of a square-wave and further extends to electrically connect with the feed part 46. The second electric connecting part 424 and the main body 422 jointly form the adjustment space 428.

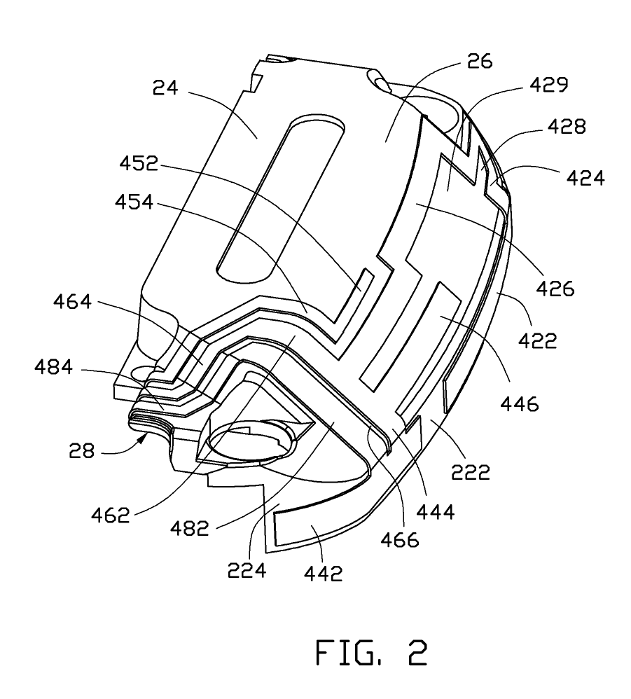

FIG. 2 is a schematic view of the antenna module 40 of FIG. 1 with a second perspective. The second antenna part 44 is also a resonant antenna and includes a head end 442, a connecting end 444, and a tail end 446. The head end 442 is rectangular and disposed on the middle portion 222 and the cambered side portion 224. The connecting end 444 is disposed on the connecting surface 26 and extends from the head end 442 to the feed part 46. The tail end 446 is disposed on the connecting surface 26 parallel to the middle portion 222. The tail end 446 further extends from the connecting end 444 to the adjustment space 429. The total length of the head end 442, the connecting end 444, and a tail end 446 is smaller than the total length of the main body 422, the first electric connecting part 424, and the second electric connecting part 426. In other words, the length of the second antenna part 44 is smaller than the length of the first antenna part 42.

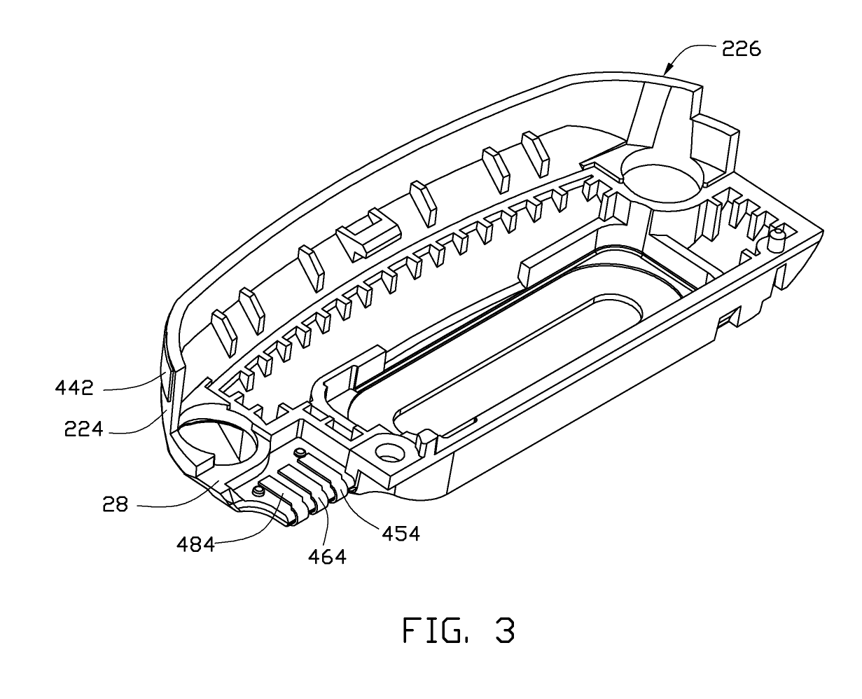

FIG. 3 is a schematic view of the antenna module 40 of FIG. 1 from a third perspective. The housing 20 further includes an inner surface 28 corresponding to the upper surface 24. The third antenna part 45 is a parasitic antenna and includes a first parasitic unit 452 and a second parasitic unit 454. The first parasitic unit 452 is rectangular and disposed on the connecting surface 26. The first parasitic unit 452 is parallel to both the first antenna part 42 and the second antenna part 44. In the exemplary embodiment, the length of the first parasitic unit 452 is approximately 4.5 mm, and the width of the first parasitic unit 452 is smaller than both widths of the second electric connecting 426 and the tail end 446. The second parasitic unit 454 is formed by extending the first parasitic unit 452 to the inner surface 28. One end of the second parasitic unit 454 is perpendicular to the first parasitic unit 452 and other end of the same is fixed on the inner surface 28. The length of the second parasitic unit 454 exceeds that of the first parasitic unit 452. The second parasitic unit 454 further connects to the ground part 48 through a conducting wire (not shown) so that the third antenna part 45 connects with the ground part 48.

The feed part 46 includes a first connecting end 462 and a feed end 464. The first connecting end 462 is rectangular and disposed on the connecting surface 26. The feed end 464 is formed by extending the first connecting end 462 to the inner surface 28 and fixed on the inner surface 28. The width of the feed end 464 is smaller than that of the first connecting end 462. The first connecting end 462 connects the feed end 464, the first antenna part 42, and the second antenna part 44 so that the first antenna part 42 and the second antenna part 44 jointly connect to the feed end 464. The feed end 464 electrically connects with a signal transmissive end of a printed circuit board (PCB) of the portable device to feed the radio frequency signals.

The ground part 48 includes a second connecting end 482 and a grounding end 484. The second connecting end 482 is rectangular and parallel to the first connecting end 462. In the exemplary embodiment, the length of the second connecting end 482 is equal to that of first connecting end 462. The grounding end 484 is formed by extending the second connecting end 482 to the inner surface 28 and fixing on the inner surface 28. The second connecting end 482 connects the grounding end 484 and the head end 442 so that the second antenna part 44 connects to the grounding end 484. As a result, the second antenna part 44 and the third antenna part 45 jointly connect with the ground part 48.

As shown in FIG. 2, the feed part 46 and the ground part 48 further form a second groove 466. The bandwidths of the antenna module 40 may be adjusted by adjusting the width of the second groove 466. In the exemplary embodiment, the width of the second groove 466 is approximately 0.5 mm. When the antenna module 40 is operative, the radio frequency signals feed in the feed part 46 and pass through paths of different lengths due to the first antenna part 42, the second antenna part 44, and the third antenna part 45. As a result, the first antenna part 42, the second antenna part 44, and the third antenna part 45 generate signals of different bandwidths so that the antenna module 40 may be operative at different communication standards, GSM850 (bandwidths of about 824-894 MHz), EGSM900 (bandwidths of about 880-960 MHz), DCS1800 (bandwidths of about 1710-1880 MHz), PCS1900 (bandwidths of about 1850-1990 MHz), and WCDMA2100 (bandwidths of about 1920-2170 MHz).

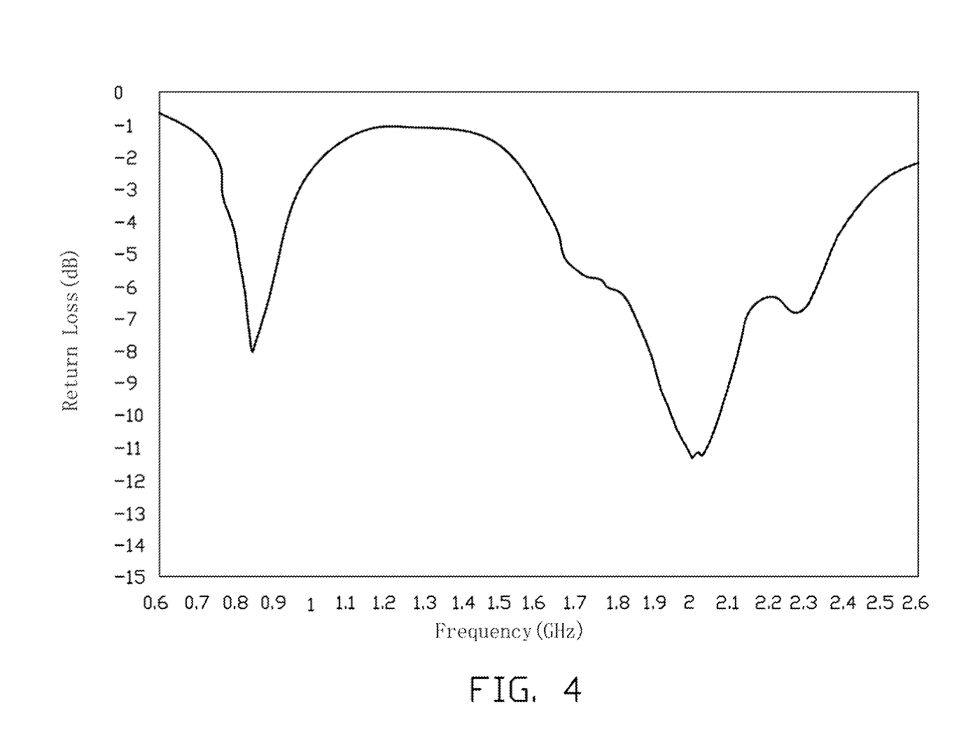

FIG. 4 is a measurement diagram of return loss of the antenna module 40 of FIG. 1. The values of return loss are −5.9 db, −4.1 db, −5.8 db, and −6.1 db corresponding to 824 MHz, 960 MHz, 1710 MHz, and 2170 MHz and satisfy the communication standards.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An antenna module, comprising:
a first antenna part and a second antenna part separated to encircle an adjustment space operable to adjust assembly of the antenna module;
a third antenna part disposed by the side of the first antenna part and the second antenna part;
a feed part and a ground part parallel to each other;
wherein the first antenna part and the second antenna part jointly connect with the feed part;
the second antenna part and the third antenna part jointly connect with the ground part; and
the first antenna part, the second antenna part, and the third antenna part are operable to generate signals of different resonant frequencies in response to radio frequency signals fed in the feed part.

2. The antenna module of claim 1, wherein the antenna module is disposed on a housing, the housing comprises:
an upper surface;
a side surface comprising a middle portion and two cambered side portions;
a connecting surface cambered and connecting the upper surface and the side surface; and
an inner surface corresponding to the upper surface.

3. The antenna module of claim 2, wherein the first antenna part further comprises a main body disposed on the middle portion and one of the cambered side portions.

4. The antenna module of claim 3, wherein the main body is rectangular with a portion of which further reaching the connecting surface.

5. The antenna module of claim 4, wherein the first antenna part further comprises a first electric connecting part disposed on the connecting surface with the form of camber.

6. The antenna module of claim 5, wherein the first electric connecting part connects with the main body and further forms a first groove operable to adjust an electric length of the first antenna part.

7. The antenna module of claim 6, wherein the first antenna part further comprises a second electric connecting part connecting with the first electric connecting part and parallel to the main body.

8. The antenna module of claim 7, wherein the second electric connecting part is in the form of a square-wave and further extends to electrically connect with the feed part.

9. The antenna module of claim 8, wherein the main body and the second electric connecting part jointly form the adjustment space.

10. The antenna module of claim 9, wherein the second antenna part comprises:
a head end disposed on the middle portion and one of the cambered side portions;
a connecting end disposed on the connecting surface, the connecting end extending from the head end to the feed part; and
a tail end disposed on the connecting surface, the tail end extending from the connecting end to the adjustment space and parallel to the middle portion.

11. The antenna module of claim 10, wherein the head end is rectangular.

12. The antenna module of claim 11, wherein the third antenna part comprises:
a first parasitic unit disposed on the connecting surface and parallel to the first antenna part and the second antenna part; and
a second parasitic unit formed by extending the first parasitic unit to the inner surface and further connecting to the ground part.

13. The antenna module of claim 12, wherein the first parasitic unit is rectangular.

14. The antenna module of claim 13, wherein the feed part comprises:
a first connecting end disposed on the connecting surface;
a feed end formed by extending the first connecting end to the inner surface; and
wherein the first connecting end connects the feed end, the first antenna part, and the second antenna part.

15. The antenna module of claim 14, wherein the first connecting end is rectangular.

16. The antenna module of claim 15, wherein the ground part comprises:
a second connecting end parallel to the first connecting end;
a grounding end formed by extending the second connecting end to the inner surface; and
wherein the second connecting end connects the grounding end and the second antenna part.

17. The antenna module of claim 16, wherein the second connecting end is rectangular.
